(19) United States
(12) Patent Application Publication
(10) Pub. No.: US 2014/0260537 A1
(43) Pub. Date: Sep. 18, 2014

(54) MOLECULAR DETECTION SYSTEM AND METHODS OF USE

(71) Applicant: Automotive Coalition for Traffic Safety, Inc., Washington, DC (US)

(72) Inventors: Grant S. Nash, Melrose, MA (US); Abdullatif K. Zaouk, Bolton, MA (US)

(21) Appl. No.: 13/838,361

(22) Filed: Mar. 15, 2013

(51) Int. Cl. G01N 30/24

(52) U.S. Cl. CPC G01N 30/24
USPC 73/23.41

(57) ABSTRACT

A system for molecular detection improves accuracy and precision of detection of molecular substances relative to other detection systems. The components, temperature, pressure, and materials used in the system allow the precise and accurate measurements of the present invention. The invention also relates to methods for using the system to detect and analyze components of a gas.

### STATEMENT REGARDING FEDERALLY SPONSORED RESEARCH OR DEVELOPMENT

This invention was supported in part by the National Highway Traffic Safety Administration of the United States Government under Contract No. DTNH22-08-H-00188. The Government may have certain rights in this invention.

### FIELD OF THE INVENTION

This invention relates to a system for molecular detection and quantitation. The system improves accuracy and precision for detection of molecular substances relative to other detection systems. The invention also relates to methods of using the system to detect and analyze components of a gas with improved accuracy and precision.

### BACKGROUND OF THE INVENTION

Gas chromatographs (GCs) are commonly used to detect and analyze molecular components in a sample. A gas chromatograph has three main components: (1) an analytical column which physically separates the components of a sample mixture; (2) an injector to introduce an amount of the sample into the analytical column for separation; and (3) a detector to sense the components after separation.

The detector of the GC detects the components in a mixture and quantifies the amount of each molecular component in the mixture. Ideally, this measurement should be accurate and precise. If the instrument fails to provide the desired accurate and precise measurements, the utility of the instrument is limited. In particular, certain calibration methods require extreme accuracy on the order of, e.g., ±800 ppb, and precision on the order of, e.g., delta 1,500 ppb.

Manufacturers of commercially available gas chromatographs claim that the gas chromatographs produce measurement accuracy out to six decimal places. In practice, however, a standard commercial gas chromatograph fails to reach the precision and accuracy required by many users.

A number of factors contribute to diminished accuracy and precision in GC measurements. Environmental inconsistencies such as external temperature and atmospheric pressure can result in varying or inaccurate readings. In addition, chemicals present in the sample can adhere or react with components in the gas chromatograph, degrading the system and diminishing its performance.

Modifications and alterations of the GC have been attempted to diminish variability and improve accuracy. Often these modifications involve heating the column of the GC to high temperatures to prevent chemicals from adhering. Other modifications may entail control of gas pressure in a sample loop. To date, these modifications have not provided the accuracy and precision required by many users.

### SUMMARY OF THE INVENTION

The present invention provides a molecular detection system to detect and quantify analytes in an accurate and precise manner. The detection system of the invention maintains two or more components of the molecular detection system at a preselected temperature of 50° C. or below. In preferred embodiments, the pressure and/or volume of the sample loop may be controlled. The invention further provides methods of detecting and quantifying molecular analytes using the system of the invention.

The molecular detection system of the invention includes the components of: (a) a gas chromatograph; (b) a gas source containing a gas mixture where the release of the gas mixture is controlled by a regulator; (c) a sample loop which contains and transfers a predetermined volume of the gas mixture into the gas chromatograph; and (d) a sample line connecting the gas source and the sample loop and providing fluid communication there between; wherein the gas chromatograph, the gas source, the sample loop, the sample line and the regulator are each maintained at a temperature within ±2.0° C. of a preselected temperature wherein the preselected temperature is selected from 50° C. or below. The preselected temperature may be selected from between about 20° C. to about 45° C. In certain embodiments, the preselected temperature is selected from about 1° C. to about 34° C., such as about 23° C. to about 34° C. In preferred embodiments, the gas chromatograph, the gas source, the sample loop, the sample line and the regulator are each maintained at a temperature within ±2.0° C. of the preselected temperature, or even within ±1.0° C. of the preselected temperature. For example, the gas chromatograph, the gas source, the sample loop, the sample line and the regulator are each maintained at a temperature within ±2.0° C. of 34° C., or even ±1.0° C. of 34° C.

The system of the invention may further comprise a back pressure-controller, in fluid communication with the sample loop, for maintaining a constant back pressure on the sample loop. The back pressure may be held constant at a pressure above the environmental atmospheric pressure experienced by the system, typically between about 1013 mbar and about 1075 mbar, such as a pressure between about 1013 mbar and about 1050 mbar. For example, the back pressure on the sample loop may be held constant at a pressure of about 1050 mbar.

The sample loop of the system may have a volume selected from 0.5 mL to 5.0 mL. In particular, the volume of the sample loop may be selected from about 0.5 mL to about 2.0 mL, such as about 0.9 mL, about 1.0 mL, about 1.1 mL or about 1.2 mL.

The sample line of the system has an interior surface which may be substantially covered with one or more passive materials. The passive materials may be selected from one or more of silicon dioxide, silcosteel, and metal oxides. In preferred embodiments, the passive material is silcosteel. In particular embodiments, one or more passive materials covers greater than 50%, such as greater than 75%, such as greater than 80%, or even greater than 90% of the interior surface of the sample line. The interior diameter of the sample line may be about ⅛ inches or less, and particularly about 1/16 inches or less.

The regulator of the system has an interior surface that may be substantially covered with one or more passive materials. For example, the surfaces in contact with the gas mixture may be substantially covered with one or more passive materials. In particular embodiments, one or more passive materials covers greater than 50%, such as greater than 75%, such as greater than 80%, or even greater than 90% of the interior surface of the regulator. The passive materials may be selected from one or more of silicon dioxide, silcosteel, and metal oxides. In preferred embodiments, the passive material is silcosteel.

The gas mixture may contain one or more analytes. In particular the one or more analytes may have molecular weights under 200 g/mol, such as under 175 g/mol, and particularly under 150 g/mol. In particular embodiments, the gas mixture contains an alcohol such as ethanol.

The invention also includes methods of using the system of the invention to achieve improved accuracy and precision. The system produces measurements with precision and accuracy that exceed that of the standard GC system. In certain embodiments, the invention provides a method for detecting and quantifying analytes in a gas sample using the system of the invention, by: a) preselecting a temperature below 50° C.; b) heating or cooling the gas chromatograph, the gas source, the sample loop, the sample line and the regulator at a temperature within ±2.0° C. of the preselected temperature; c) adjusting the regulator to release the gas mixture from the gas source to the sample line and the sample loop; d) injecting a sample of the gas mixture from the sample loop into the column of the GC; e) detecting and quantifying the analytes in the gas sample with a detector; and f) maintaining the components of the detection system at ±2.0° C. of the preselected temperature throughout steps c through e.

In certain embodiments, the method for detecting and quantifying one or more analytes in a gas sample, includes: a) selecting a temperature below 50° C. as the preselected temperature; b) heating or cooling two or more of the components of a molecular detection system in contact with the gas sample to within ±2.0° C. of the preselected temperature, where the components of the molecular detection system in contact with the gas sample include a gas chromatograph, a gas source containing a gas mixture where release of the mixture is controlled by a regulator, a sample loop which contains and transfers a predetermined volume of the gas mixture into the gas chromatograph and a sample line which connects the gas source and the sample loop and provides fluid communication there between; c) adjusting the regulator to release the gas mixture from the gas source to the sample line and the sample loop; d) injecting a sample of the gas mixture from the sample loop into the column of the gas chromatograph; e) detecting and quantifying the analytes in the gas sample with a detector; and f) maintaining the two or more components of the detection system at ±2.0° C. of the preselected temperature throughout steps c through e. The method may further include appending a back pressure-controller on the sample loop to control the back pressure in the sample loop. The volume of the sample loop of the method may be selected from 0.5 mL to 5.0 mL such as about 1.0 mL.

### BRIEF DESCRIPTION OF THE DRAWINGS

Further features of the invention, its nature and various advantages will be apparent upon consideration of the following detailed description, taken in conjunction with the accompanying drawings, in which:

FIG. 1 is a schematic illustration of the molecular detection system of the invention;

FIG. 2 depicts the molecular detection system of the invention;

FIG. 3 depicts a perspective view of a pressure regulator/gauge for regulating the release of the gas mixture from the gas source;

FIG. 4 depicts a top plan view of the pressure regulator/gauge of FIG. 3, taken from line 4-4 of FIG. 3;

FIG. 5 depicts a front elevational view of the pressure regulator/gauge of FIGS. 3 and 4, taken from line 5-5 of FIG. 3;

FIG. 6 depicts the sample loop wrapped with a heat wrap to modulate the temperature of the sample loop;

FIG. 7 is a schematic illustration of an automatic back pressure-controller and the flow of sample gas from the sample loop through the controller to exhaust;

FIG. 8 depicts ethanol concentration of multiple 209 ppm samples using a non-homogenous molecular detection system;

FIG. 9 depicts ethanol concentration of multiple 159 ppm samples using a partial-homogenous molecular detection system;

FIG. 10 depicts ethanol concentration of multiple 211,100 ppb samples using a homogenous molecular detection system;

FIG. 11 depicts ethanol concentration of multiple 211 ppm samples using a molecular detection system without a back pressure-controller at 30° C. where atmospheric pressure during one testing period is ˜1016 mbar and ˜1024 mbar at another testing period;

FIG. 12 depicts the effect of high back pressure on ethanol measurements;

FIG. 13 depicts the effect on ethanol peak height, peak area and retention time when sample loop temperature and column temperature are modulated together.

FIG. 14 depicts the ethanol peak height as temperature at the sample loop and column decrease together.

FIG. 15 depicts the ethanol peak area as temperature at the sample loop and column decrease together.

FIG. 16 depicts the effect on ethanol peak height as the temperature of the sample loop decreases and the temperature of the column remains constant; and

FIG. 17 depicts the effect on ethanol peak height by variation of gas source temperature in comparison with variation of sample line temperature.

### DETAILED DESCRIPTION OF THE INVENTION

Gas chromatographs are commonly used to detect and quantify molecular substances, also referred to herein as analytes. While a powerful tool for molecular detection, gas chromatographs fail to provide the precision and accuracy required by some users. For example, a GC user preparing calibration samples may require that samples measure as close as possible to the actual concentration, i.e., accuracy, and that each of multiple identical samples do not vary from each other, i.e., precision. The targeted accuracy may fall within ±800 ppb and particularly ±400 ppb of the actual concentration in a sample. The targeted precision may fall within delta 1,500 ppb, and particularly delta 1,000 ppb, wherein the delta is the difference between the highest and lowest measurements. The standard GC system and methods fail to meet these target values in a consistent and predictable way.

The present invention provides a molecular detection system and methods for use with highly accurate and precise measurements. The invention provides modifications to a GC and pre-injection elements to achieve measurements with improved accuracy and precision relative to standard GC measurements. As used herein, “the molecular detection system” or “the system” refers to the GC and pre-injection elements. Pre-injection elements are the elements leading up to injection into the column of the GC. These elements include at least the gas source, the sample line, and the sample loop. Additional pre-injection elements include a pressure regulator/gauge on the gas source and a back pressure-controller on the sample loop. The pre-injection elements may include all of the components in contact with a gas mixture in the immediate lead up to injection into the column. For example, a gas mixture may contact a gas source, a regulator, a sample line, a sample loop and an inlet prior to entering the column of the GC. In other embodiments, a gas mixture contacts a sample loop and inlet prior to entering the column of the GC.

The gas chromatograph, as referred to herein, includes a column within an oven and may also include components such as the inlet to the column. The temperature modulation and control at the GC includes modulating and controlling the temperature of any component of the GC which contacts the gas mixture. Elements of the GC that are not in contact with the gas mixture may not be temperature controlled. For example, the computational components of the GC are not typically temperature controlled.

FIG. 1 depicts a schematic illustration of an exemplary molecular detection system of the invention. A gas source, regulated by a pressure regulator/gauge, releases a gas mixture into a sample line. The sample line then feeds the gas mixture into a sample loop located in a valve box. The sample loop typically has a known volume and once the gas mixture reaches the sample loop it may be referred to herein as the gas sample. The sample loop may be connected to a back pressure-controller to maintain a desired pressure in the sample loop. The gas sample in the sample loop is injected into the column of the GC and is carried by an inert carrier gas through the length of the column. A detector at the outlet of the column measures the concentration of the molecular analytes in the sample.

FIG. 2 depicts one experimental setup of the system described herein. The gas source 4 contains a gas mixture for sampling. The pressure regulator/gauge 3 controls the release of the gas mixture from the gas source 4. The sample line 1 carries the gas to the sample loop in the valve box 8. The pressure on the sample loop is controlled by a back pressure-controller 2. A sample of the gas mixture is injected in the column inlet 5 into the column which is located in the oven of the GC 6. The sample travels through the column to an FID detector where the analytes are measured. The components, temperature controls, pressure controls, volume controls, and materials used in the system allow precise and accurate measurements according to the present invention.

In certain embodiments, the molecular detection system of the invention includes the components of: (a) a gas chromatograph; (b) a gas source containing a gas mixture where the release of the gas mixture is controlled by a regulator; (c) a sample loop which contains and transfers a predetermined volume of a sample of the gas mixture into the gas chromatograph; and (d) a sample line connecting the gas source and the sample loop and providing fluid communication there between; wherein the gas chromatograph, the gas source, the sample loop, the sample line and the regulator are each maintained at a temperature within ±2.0° C. of a preselected temperature wherein the preselected temperature is selected from 50° C. or below.

In other embodiments, the molecular detection system of the invention includes the components of: (a) a gas chromatograph; (b) a gas source containing a gas mixture where the release of the gas mixture is controlled by a regulator; (c) a sample loop which contains and transfers a predetermined volume of a sample of the gas mixture into the gas chromatograph; and (d) a sample line connecting the gas source and the sample loop and providing fluid communication there between; wherein the gas chromatograph, the gas source, the sample loop, the sample line and the regulator are each maintained within a preselected temperature range wherein the preselected temperature range is selected from below 50° C.

The gas source of the invention may be selected from any type of containment but particularly a gas tank or a mechanical lung. In particular embodiments, the gas source is a gas tank containing one or more gaseous analytes in a gas mixture. In certain embodiments, the gas tank may be rolled prior to use to homogenize the gas mixture. In other embodiments, the gas source is a mechanical lung capable of simulating breath samples with one or more analytes. A mechanical lung may, for example, warm and humidify the gas mixture and combine one or more different gases in a gas blender. A mechanical lung may warm the gas mixture to the preselected temperature with an oven. In certain embodiments, a mechanical lung is connected via one or more sample lines to the actuator valve system at the valve box of the GC.

The regulator of the invention is not limited to any particular device but instead includes all regulators that would be useful for the present invention. A regulator is preferably combined with a pressure gauge. In particular embodiments, a regulator is used to control release of a gas mixture from a gas source selected from a gas tank. FIG. 3 depicts one view of a pressure regulator/gauge of the invention. FIG. 4 depicts a top down view of the pressure/regulator gauge while FIG. 5 depicts the front view of the gauge dials of the pressure regulator/gauge. In each of FIG. 3-5, the regulator is represented by 9. The regulator 9 depicted in FIG. 3 is a KCY Dual Stage Regulator with 316 SS and SilcoNert 2000 coating with 0-100 psi range and 3600 psi max, F Flow path, ¼ inch FNPT ports, PCTFE seats, 0.06 Cv, diagram sensing without vent, knob handle and panel mount first stage. In each of FIG. 3-5, 10 represents an SS gauge with 2.5 inch face, 0-6000 psi with ¼ lower mount MNPT and 11 represents a PGI series gauge with 316 SS, a 2.5 inch face, 0-160 psi range with a with ¼ lower mount MNPT. In each of FIG. 3-5, 12 represents an SS, SilcoNert 2000 coated tube adaptor with ¼ inch tube stub by ¼ inch MNPT. In each of FIG. 3-5, 13 represents an SS T series needle valve with ¼ swage ends.

In certain aspects of the invention, the temperature of two or more elements of the GC and its pre-injection elements, are held at the same or similar temperatures. For example, the column of a gas chromatograph as well as any one or more of the sample loop, the sample line, the inlet, the gas source and a pressure regulator/gauge are each maintained at the same preselected temperature. In some embodiments, two or more components of the GC and pre-injection elements are maintained at the same preselected temperature or temperatures within ±2.0° C., such as within ±1.0° C. of a preselected temperature.

For example, for a preselected temperature of 30° C., the temperature of the column is maintained at 30° C., the sample loop at 29.5° C., and the sample line is maintained at 29° C. In particular embodiments, the two or more elements of the GC and pre-injection elements are held at a temperature within ±1.0° C. of a preselected temperature, within ±0.5° C. or within ±0.1° C. of a preselected temperature.

The preselected temperature may be selected from any temperature but particularly temperatures 50° C. or below, and preferably from 0° C. to 34° C. In one example, each of the gas source, the pressure regulator/gauge, the sample line, the sample loop, the inlet and the column are maintained at a temperature preselected from between 23° C. and 45° C., such as about 34° C. In another example, two or more components of the system are maintained at a temperature selected from between 10° C. and 23° C., such as about 15° C.

In other aspects of the invention, the temperature of two or more elements of the GC and its pre-injection elements, are held at temperatures selected from a preselected temperature range. In particular, the preselected temperature range is selected from ranges below 50° C. For example, the column of a gas chromatograph as well as any one or more of the sample loop, the sample line, the gas source, the inlet, and a pressure regulator/gauge are each maintained at a temperature independently selected from within a 10° C. range such as within an 8° C. range or even within a 5° C. range. In preferred embodiments, the temperature of an individual component of the system is maintained at a higher temperature within the range the closer it is to the detector. With respect to proximity to the detector, the gas source is furthest from the detector, followed by the pressure regulator/gauge, then the sample line, then the sample loop and finally the gas chromatograph is the closest component to the detector, as depicted in FIG. 1.

For example, for a preselected temperature range of 23-30° C., the gas source is maintained at 24° C., the sample line is maintained at 26° C., the sample loop at 28° C., and the temperature of the column is maintained at 30° C. In another example, for a preselected temperature range of 11-20° C., the gas source is maintained at 11° C., the sample line is maintained at 12° C., the sample loop at 15° C., and the temperature of the column is maintained at 20° C.

The term “preselected” as used herein refers to the selection of a temperature or temperature range, prior to testing samples on the GC. For a preselected temperature, a single temperature is selected and two or more components of the system are set and maintained at the selected temperature. For a preselected range, the temperature range is selected, e.g., 0° C. to 8° C. range, and one or more components of the system are set and maintained at a temperature within the preselected range. The preselected temperature or range may be preselected based upon the boiling point and/or vapor pressure of the molecular analyte or analytes in a sample. The preselected temperature may be inversely proportional to the vapor pressure of the analyte(s) in the sample. For example, a sample containing analytes with high vapor pressures may be suitable in a system with a lower preselected temperature. Alternatively, the preselected temperature may be proportional to the vapor pressure of the analyte(s) in the sample. For example, a sample containing analytes with high vapor pressures may be suitable in a system with a higher preselected temperature.

The temperature of each of the components of the GC and pre-injection elements may be maintained at the preselected temperature for a specified period of time, for example, until equilibrium is achieved. This period of time may include a period of time prior to injecting a sample into the GC, and during testing and detection of a sample. For example, one or more components of the GC and pre-injection elements may be held at a preselected temperature for at least ten minutes prior, at least five minute prior, or at least one minute prior to injection of the sample into the GC column. One or more components of the GC and pre-injection elements may be held at the preselected temperature throughout the testing of a sample, e.g., from the time the sample enters the sample line or sample loop until it reaches the detector. One or more components of the system may be maintained at a preselected temperature for a period selected from between one minute to one hour prior to injection of a sample into the GC until a time when the sample has been detected by the detector. For example, one or more components of the system may be maintained at a preselected temperature for a period selected from about one hour or less, about 45 minutes or less or about 30 minutes or less prior to injection of the sample into the GC.

In order to maintain the preselected temperature at two or more components of the system, the invention may use one or more devices to detect and modulate temperature as described below. Convection and/or conduction devices may be used on one or more of the components of the system to heat and/or cool the system to a desired temperature. For example, a heat wrap or equivalent device may be used to maintain a certain temperature at, for example, the sample loop or the gas source. FIG. 6 depicts one method for maintaining a specified temperature at the sample loop. In FIG. 6, a heat wrap is wrapped around the sample loop to maintain a desired temperature.

To cool the components of the system, chillers, peltier devices or cold baths may be used. For example, refrigeration tubing such as ¼ inch OD copper tube may be wrapped around any of the gas source, the pressure regulator/gauge, the sample line and/or the sample loop to cool these components. In certain embodiments, the cooling coils are connected to a chiller such as a Remcor Model 550A Chiller. One or more components of the system such as the sample loop or sample line may be cooled in an ice bath such as a water ice bath or an isopropanol/dry ice bath. Any one or more components of the system may be insulated, for example, with aluminum foil, to maintain a desired temperature.

The column of the GC, may be temperature-controlled by a heating or cooling system associated with the gas chromatograph, e.g., the oven. In certain embodiments, the oven is modified to incorporate a heating or cooling device. The GC may be cooled though the use of a cryo kit. In some embodiments, the GC is cooled by feeding liquid nitrogen into the cryogenic valve of the GC. Peltier devices are also preferred devices for cooling components of the system.

Devices such as thermocouples, thermistors, silicon band temperature sensors and resistance temperature detectors may be employed to determine, and where applicable control, the temperature for one or more components of the system. For example, a thermistor may be used to control and maintain the preselected temperature at the sample loop and the sample line. In another example, each of the gas source, the sample line, the sample loop, and the column are monitored and controlled by a thermistor to maintain a homogenous temperature.

FIG. 8 depicts ethanol measurements of multiple 209 ppm samples in a non-homogenous system. In this system the temperature of the column is 80° C. and the pre-injection elements are not temperature controlled. The accuracy and precision of this system, as seen in Table 2 of the examples, are far from the desired targets of accuracy and precision. In comparison, FIG. 9 depicts ethanol measurements with a partial-homogeneous system. In the partial-homogenous system depicted in FIG. 9, each of the gas source, sample line, sample loop, and column are set and maintained at a preselected temperature. In the partial-homogenous system depicted in FIG. 9, a 1/16 inch diameter sample line with silcosteel coating on the interior surface is used. In addition, the sample loop has a volume of 1.0 mL. The accuracy and precision of this system, as seen in Table 2 of the examples, are improved over the system of FIG. 8.

The regulator of the system may also be temperature controlled. As the gas passes from the gas source to the sample line through the pressure regulator/gauge, the temperature may be controlled through the use of a heating or cooling device. In one example, a heat wrap is used to control the temperature of the pressure regulator/gauge. Exemplary heat wraps include the wraparound heating cord from Omega®. A heat wrap may be wrapped around the pressure regulator/gauge to maintain the gas traveling through the pressure regulator/gauge at the preselected temperature. For example, the gas source is heated to maintain the gas mixture at 34° C.±1.0° C. and after the gas passes through the regulator, the gas entering the sample line is within ±1.0° C. of 34° C.

One or more components of the system may be purged, e.g. the gas source, the pressure regulator/gauge, the sample line, and the sample loop, by flushing gas through the one or more components prior to injecting samples into the GC. The gas regulator/gauge may be purged, e.g., prior to introducing different molecular components or even when different molecular components are not introduced, to clean and eradicate any residual molecules within the geometry of the gas pathway. Flushing and purging the pressure regulator/gauge before starting any new measurement set is preferred.

FIG. 10 depicts ethanol measurements of a homogenous system at 30° C. In the homogenous system, each of the gas source, the pressure regulator/gauge, the sample line, the sample loop, the inlet, and the column are set and maintained at a uniform temperature of 30° C.±1.0° C. In the homogenous system depicted in FIG. 10, the components of the system were purged prior to testing, a 1/16 inch diameter sample line with silcosteel coating on the interior surface was used, a silco-nert pressure regulator/gauge was used, the sample loop had a volume of 1.0 mL and the sample loop back pressure was held constant with a back pressure-controller. The accuracy and precision of this system is superior to the systems depicted in FIG. 8 and FIG. 9 and achieves targeted goals as seen in Table 2.

One aspect of the invention is maintaining a pressure drop in the system from the source of the gas mixture to the column of the GC. In particular, the pressure in the sample line and the sample loop is maintained at a pressure higher than the pressure of the column of the GC. The pressure in the sample loop is preferably higher than the pressure in the column, such as greater than 5% higher, greater than 10% higher, greater than 30% higher, greater than 50% higher, or even greater than 80% higher. For example, the pressure in the sample loop is maintained at a pressure of 20 psi while the pressure in the column is 10 psi.

In certain embodiments, the pressure in the sample loop is controlled by a back pressure-controller. As depicted in FIG. 11, small differences in atmospheric pressure may negatively impact the accuracy of a measurement. As seen in FIG. 11, a variation in atmospheric pressure from ˜1016 mbar to ˜1024 mbar altered the ethanol gas measurement by ˜2 ppm from the actual concentration. Table 3 in the examples depicts the concentration measurements when the back pressure in the sample loop is not regulated. FIG. 12 depicts the effect of removing sample loop back pressure-control on the accuracy of ethanol measurements.

In certain embodiments, a back pressure-controller attached to the sample loop holds the back pressure in the sample loop at a constant value. The constant back pressure may be set at a value greater than the atmospheric pressure, for example, at a pressure greater than 1013 mbar. For example, the back pressure-controller may be set at a value of at least 5 mbar greater than atmospheric pressure, such at least 15 mbar greater than atmospheric pressure or at least 30 mbar greater than atmospheric pressure. Atmospheric pressure may be determined as of the time and location that the system is being used. The constant back pressure value may be selected from between 1013 mbar and 1074 mbar or even selected from between 1035 mbar and 1074 mbar. In particular embodiments, the back pressure is held at a pressure selected from above 1035 mbar.

FIG. 7 depicts a schematic of a back pressure controller and the flow of gas to maintain constant back-pressure. Exemplary back pressure-controllers include the Alicat pressure controller PC Series and the Brooks® pressure controller SLA7810/10. Table 4 in the examples depicts the concentration measurements when the back-pressure is held constant at 1050 mbar with a back pressure-controller.

Another aspect of the invention is controlling the volume of the sample loop. The volume of the sample loop may be selected from 0.5 mL to 8 mL such as from 0.5 mL to 5 mL. For example, the sample loop may hold 0.5 mL or 1.0 mL of a gas sample. In particular, the sample loop may hold less than 2 mL, such as less than 1.0 mL of a gas sample.

Another aspect of the present invention is the passivation of materials in contact with the gas mixture or sample to reduce or avoid retention and reactivity of chemicals within the system. Passivating the system may prevent analyte molecules from sticking to the pathway surfaces. Passive materials of the invention can include, for example, silcosteel, silicon nitride, silicon dioxide or metal oxides such as aluminum oxide or titanium oxide. In particular, the sample line and/or the pressure regulator may be substantially covered on the interior surface with one or more materials that reduce reactivity and retention of the analytes in the gas mixture. For example, the sample line and/or the pressure regulator may be substantially covered on the interior surfaces with one or more of silicon nitride, silicon dioxide, titanium dioxide or silcosteel. The invention includes any similar materials that are capable of preventing retention of analyte molecules in the gas pathway.

Another aspect of the invention is the use of a sample line with a narrow interior diameter. The sample line may have an interior diameter of ¼ inches or less or particularly ⅛ inches or less or more particularly 1/16 inches or less. The internal diameter of the sample line may be selected from ⅛ to 1/16 inches in diameter such as 1/16 inches. In certain embodiments, the interior diameter is 1/16 inches and the interior surface is substantially covered with a passive material such as silcosteel.

The system of the invention is preferably used with gaseous samples. Samples of the invention may be gas mixtures with one or more analytes. The gaseous analyte may be selected from small molecules with molecular weights 200 g/mol and below, particularly 175 g/mol and below, or more particularly 150 g/mol and below. Samples may include organic molecules such as alcohols, aldehydes, alkanes, alkynes, alkenes, amines, and thiols. In particular embodiments, the gaseous samples may contain an alcohol such as ethanol.

The detector for the molecular detection system of the invention may be selected from any type of detector used in the field. Exemplary GC detectors include an atomic emission detector (AED), an electron-capture detector (ECD), a flame ionization detectors (FID), a mass spectrometer (MS), a photoionization detector (PID), and a thermal conductivity detector (TCD). In preferred embodiments, the detector is a flame ionization detector.

The accuracy may be determined by examining the difference between a single measurement and the actual concentration. A summary of the accuracy may be reported in an average concentration of two or more samples in relation to the actual concentration. The accuracy calculation may exclude samples from early in sampling. For example, the accuracy calculation may exclude the first ten or fewer measurements or even the first five or fewer measurements.

The accuracy of a single measurement of concentration of a sample preferably falls within ±1,000 ppb of the actual concentration of the sample. For multiple samples, the average concentration of the samples preferably falls within ±1,000 ppb of the actual concentration of the samples. For example, the average concentration of multiple gas samples is within ±1,000 ppb, such as within ±750 ppb, or even within ±500 ppb of the actual concentration of the samples. In preferred embodiments, the average concentration is within ±500 ppb of the actual concentration of the samples.

The precision may be determined by taking the difference between the sample with the highest measured concentration and the lowest measured concentration. The precision calculation may exclude samples from early in sampling. For example, the precision calculation may exclude the first ten or fewer measurements, or even the first five or fewer measurements.

Using the system of the invention, the precision of the measurement of two or more samples is within about 2,000 ppb, such as within 1,750 ppb, such as within 1600 ppb. In preferred embodiments, the precision is within 1500 ppb, such as within 1,250 ppb, or even within 1,000 ppb.

The invention further provides methods for detecting molecules in a sample with accuracy and precision. Any one or more of the embodiments of the system described herein may also apply to the method discussed herein. For example, passivation of interior surfaces of the sample line and gas regulator; maintaining temperature at two or more components of the system for periods of time; purging one or more components of the system; controlling sample loop volume/temperature/pressure; sample line diameter, etc., are embodiments that may be part of the disclosed methods.

In certain embodiments, the invention provides a method for detecting and quantifying analytes in a gas sample using the system of the invention described herein, by: a) preselecting a temperature below 50° C.; b) heating or cooling the gas chromatograph, the gas source, the sample loop, the sample line and the regulator at a temperature within ±2.0° C. of the preselected temperature; c) adjusting the regulator to release the gas mixture from the gas source to the sample line and the sample loop; d) injecting a sample of the gas mixture from the sample loop into the column of the GC; e) detecting and quantifying the analytes in the gas sample with a detector; and f) maintaining the components of the detection system at ±2.0° C. of the preselected temperature throughout steps c through e. In certain embodiments, the regulator is adjusted to release the gas mixture from the gas source prior to heating or cooling one or more of the gas chromatograph, the gas source, the sample loop, the sample line and the regulator at a temperature within ±2.0° C. of the preselected temperature. In such embodiments, step c may come before step b of the method.

In certain embodiments, the method for detecting and quantifying one or more analytes in a gas mixture, includes: a) selecting a temperature below 50° C. as the preselected temperature; b) heating or cooling one or more of the components of a molecular detection system in contact with the gas mixture to within ±2.0° C. of the preselected temperature, where the components of the molecular detection system in contact with the gas mixture include a gas chromatograph, a gas source containing a gas mixture where release of the mixture is controlled by the regulator, a sample loop which contains and transfers a predetermined volume of the gas mixture into the gas chromatograph and a sample line which connects the gas source and the sample loop and provides fluid communication there between; c) adjusting the regulator to release the gas mixture from the gas source to the sample line and the sample loop; d) injecting a sample of the gas mixture from the sample loop into the column of the gas chromatograph; e) detecting and quantifying the analytes in the gas sample with a detector; f) maintaining the components of the detection system at ±2.0° C. of the preselected temperature throughout steps c through e.

The preselected temperature of the method may be selected from 0° C. and 34° C., such as from 10° C. and 23° C. In certain embodiments, the components of the system are maintained at the preselected temperature for a period of about five minutes or greater or ten minutes or greater prior to injection of the sample into the GC. In certain embodiments, one or more components of the system may be maintained at a preselected temperature for a period selected from about one hour or less, about 45 minutes or less or about 30 minutes or less prior to injection of the sample into the GC. In certain embodiments, the components of the molecular detection system are heated or cooled to within ±1.0° C. of the preselected temperature. In certain embodiments, the components of the molecular detection system are maintained within ±1.0° C. of the preselected temperature throughout steps c through e.

In other embodiments, the invention further provides methods for detecting molecules in a sample with accuracy and precision. The method for detecting and quantifying one or more analytes in a gas mixture, includes: a) selecting a range of temperatures below 50° C. as the preselected temperature range; b) heating or cooling the components of a molecular detection system in contact with the gas mixture to a temperature within the preselected temperature range, where the components of the molecular detection system in contact with the gas mixture include a gas chromatograph, a gas source containing a gas mixture where release of the mixture is controlled by the regulator, a sample loop which contains and transfers a predetermined volume of the gas mixture into the gas chromatograph and a sample line which connects the gas source and the sample loop and provides fluid communication there between; c) adjusting the regulator to release the gas mixture from the gas source to the sample line and the sample loop; d) injecting a sample of the gas mixture from the sample loop into the column of the gas chromatograph; e) detecting and quantifying the analytes in the gas sample with a detector; and f) maintaining the components of the detection system within the preselected temperature range throughout steps c through e. In certain embodiments, the regulator is adjusted to release the gas mixture from the gas source prior to heating or cooling one or more of the gas chromatograph, the gas source, the sample loop, the sample line and the regulator to a temperature within the preselected temperature range. In such embodiments, step c may come before step b of the method.

In certain embodiments, the column of a gas chromatograph as well as any one or more of the sample loop, the sample line, the gas source and a pressure regulator/gauge are each maintained at a temperature independently selected from within a 10° C. range such as within an 8° C. range. In preferred embodiments, the temperature of an individual component of the system is higher the closer it is to the detector. The gas source being furthest from the detector, followed by the pressure regulator/gauge, then the sample line, then the sample loop, and finally the gas chromatograph being the closest component to the detector, as depicted in FIG. 1.

In certain embodiments of the method, one or more components of the system may be maintained within a preselected temperature range for a period selected from about one hour or less, about 45 minutes or less or about 30 minutes or less prior to injection of the sample into the GC.

In certain embodiments, the gas source may be mixed by, for example, rolling a gas tank in order to homogenize the contents. In particular, the gas source may be mixed prior to the step a, b or c of the method. In certain embodiments, one or more components of the system is flushed prior to adjusting the regulator to release the gas source. For example, one or more of the pressure regulator, the sample line, the sample loop and the column may be flushed to remove residual analytes from the system. In particular, the one or more components may be flushed prior to step a, b or c of the method.

The methods may further include appending a back pressure-controller on the sample loop to control the back pressure in the sample loop. The back pressure-controller may be set at a constant pressure greater than atmospheric pressure such as a pressure selected from at least 5 mbar greater than atmospheric pressure, at least 10 mbar greater than atmospheric pressure or at least 20 mbar greater than atmospheric pressure. The pressure in the sample loop is preferably higher than the pressure in the column, such as greater than 5% higher, greater than 10% higher, greater than 30% higher, greater than 50% higher, or even greater than 80% higher. For example, the pressure in the sample loop is maintained at a pressure of 20 psi while the pressure in the column is 10 psi.

In certain embodiments, the sample loop used in the method may have a volume selected from 0.5 mL to 5.0 mL, such as from about 1.0 mL to about 1.3 mL. In particular, the volume of the sample loop may be about 1.0 mL.

The sample line and/or the pressure regulator of the method may be substantially covered on the interior surface with one or more materials that reduce reactivity and retention of the sample. For example, the sample line and/or the pressure regulator may be substantially covered on the interior surfaces with one or more of silicon nitride, silicon dioxide, titanium dioxide or silcosteel. The invention includes any similar materials that are capable of preventing retention of analyte molecules in the gas pathway.

The sample line of the method may have an interior diameter of ¼ inches or less or particularly ⅛ inches or less or more particularly 1/16 inches or less. The internal diameter of the sample line may be selected from ⅛ to 1/16 inches in diameter such as 1/16 inches. In certain embodiments, the interior diameter is 1/16 inches and the interior surface is substantially covered with a passive material such as silcosteel.

Samples of the invention may be gas mixtures with one or more analytes. The gaseous analyte may be selected from small molecules with molecular weights 200 g/mol and below, particularly 175 g/mol and below, or more particularly 150 g/mol and below. Samples may include organic molecules such as alcohols, aldehydes, alkanes, alkynes, alkenes, amines, and thiols. In particular embodiments, the gaseous mixture of the method contains an alcohol such as ethanol.

### Equivalents

The present invention provides among other things methods and systems for measuring analytes with precision and accuracy. While specific embodiments of the subject invention have been discusses, the above specification is illustrative and not restrictive. Many variation of the invention will become apparent to those skilled in the art upon review of this specification. The full scope of the invention should be determined by reference to the claims along with their full scope of equivalents, and the specification along with such variations.

### EXAMPLES

### Example 1

### Procedure for when Stratification is Present in the Gas Source

This procedure is established as a standard for rolling a 3,986 L Ethanol gas tank in times when stratification is present in a gas source cylinder. This procedure is to facilitate equilibrium distribution of the gas within the tank. This issue is less apparent in smaller tanks such as 105 L gas tanks. A 3,986 L gas tank is connected to the sample line. The pigtail should be disconnected with a pipe wrench. The cylinder is capped and laid on it side on the floor. Marking a starting point and end point, the cylinder is rolled approximately 6 ft.

After the gas cylinder is rolled back and forth 20 times within a 5 minute interval, it is moved back to the sample line of the system and reconnected to the pigtail with a pipe wrench. Since the space between the legs of the bench is approximately 6 ft, and the tank circumference is approximately 25.5 in, the distance the tank is rolled is shown in Equations 1 and 2:

Dᵣ₂=6 ft*20*2=240 ft 1

Dᵣ₁=25.5 in/12 in/ft*˜112.94 times=240 ft 2

The Ethanol tank should settle for 45 minutes, vent for 20 seconds using the toggle on the sample line before being used for testing.

### Example 2

### Procedure for GC Calibration

In order to process and analyze data for a GC, the GC is calibrated for ethanol measurements. The process employs a five point calibration, in which gas sources of five different ethanol concentrations are utilized (e.g. concentrations, in ppb, of 54,500, 106,700, 165,000, 211,100, and 317,800). An exemplary gas source is held in a stainless-steel 105 L gas tank at 1,000 psi. A data set of ethanol measurements are obtained for each concentration. An average is then taken of the data samples and a calibration data set is obtained, see tabular data in Table 1.

TABLE 1
A Calibration Data Set

| Concentration | Ethanol Peak Height | Ratio of Peak Height |
|---|---|---|
| ppb | pA | to Concentration *10³ |
| 54,500.0 | 48.171149 | 0.88387430 |
| 106,700.0 | 94.348728 | 0.88424300 |
| 165,000.0 | 148.628928 | 0.90078138 |
| 211,100.0 | 193.404330 | 0.91617399 |
| 317,800.0 | 289.911394 | 0.91224479 |
| | AVERAGE | 0.88963289 |
| | STDEV | 0.00965664 |
| | RSD | 1.0855% |
| | RSQ value | 0.99985436 |

Once the calibration data set is obtained, it is inputted into the GC software. Ethanol measurements can then be converted from raw, uncalibrated values, which utilize current, in Pico-Amps (pA), to calibrated values in ppb. Calibrated data sets are needed whenever independent variables affect the ethanol measurement (e.g. with and without passivated surfaces, with and without pressure regulator/gauge purging, with non-homogeneous system, with homogeneous system, for independent temperatures of a homogeneous system, etc.)

### Example 3

### Procedure for Passivating Sample Line

It has been observed in previous tests that ethanol molecules can stick to the sample line when ¼ in. stainless steel sample lines are used. Over time, the molecules become dislodged and increase the perceived ethanol concentration measurement for a sample. A settling process occurs in order to reach equilibrium. Passivating the sample line can prevent ethanol molecules from adhering to the surface along the path to the detector. A silco-steel sample line ( 1/16 in.) thermally regulated may be utilized for passivating the system.

The silco-steel sample line is routed via a needle valve to the sample valve Position #8. A control algorithm then activates the port position controller for port position #8 and deactivates port position #1 for the gas mixture to enter the valve box setup.

### Example 4

### Test Procedure for Thermally Controlling Sample Loop

The following procedure is used to control the sample loop temperature. The sample gas travels from the gas source to the pressure regulator/gauge to the sample line to the sample loop in the valve box to the inlet to the column before being measured at the detector. It was discovered that in the standard setup, the sample loop temperature in the valve box was less than the temperature of the heat plates in the valve box, proportional to the amount of heat being controlled, e.g., 25° C. less when the valve box plates are set at 80° C.

The sample loop is thermally controlled and monitored as follows:

1. A thermocouple is applied to the actuator valve base of the sample loop.

2. A thermocouple is applied to the sample loop.

3. A thermocouple is applied to the vertical heat plate.

4. A thermocouple is used to measure the air temperature of the valve box.

5. A thermocouple temperature reader monitors the thermocouple temperatures.

6. If the temperature of the sample loop varies from that of the valve box plate, the sample loop temperature may be controlled by an alternate method. An actuator valve base heater can be applied to the valve directly to heat the sample loop.

7. If the actuator valve base heater does not sufficiently warm the sample loop to the desired temperature, a heat wrap around the sample loop can be utilized with a temperature controller to control the sample loop temperature. The thermocouple becomes the sensor for the control feedback loop. When the temperature at thermocouple decreases, a voltage signal is sent to the heat wrap to increase the temperature of the wrap and thus the temperature of the sample loop.

### Example 5

### Procedure for Evaluating the Effect of the Sample Loop and Column Temperature on Ethanol Measurements

This procedure identifies the effect of sample loop and column temperature on the GC Ethanol measurement. A heat wrap should be applied to the sample loop. The sample loop should be monitored with a thermocouple and controlled with a temperature controller per the procedure outlined in Example 4. The column temperature is monitored with a thermocouple attached to the column and a thermocouple temperature reader receiving, storing, and displaying the column temperature. A thermocouple controller controls the temperature of the GC oven via Chemstation Software.

A test was conducted varying the sample loop and column temperature together. FIG. 13 shows the effect that temperature has on the shape of the analyte curve during measurement. As temperature decreases, the retention time increases; the peak height decreases; the peak width increases; and the peak area increases. FIG. 14 and FIG. 15 show the ethanol peak height and peak area for an example when the sample-loop/column temperature is decreasing.

A test was conducted varying the sample loop temperature while keeping the column temperature constant. FIG. 16 shows the effect that sample loop temperature has on the ethanol measurement. As the sample loop temperature decreases the peak height increases and the peak width stays the same. This is due to an expansion with the sample loop, which increases the volume, in which the gas concentration becomes less dense with less moles/mL.

### Example 6

### Test Procedure for Thermally Controlling the Gas Source and Pressure Regulator/Gauge

A procedure for thermally controlling the gas source and pressure regulator/gauge was used, as part of an overall effort to create a homogeneous system for measuring an analyte with a GC. The sample gas travels from the gas source to the pressure regulator/gauge to the sample line to the sample loop in the valve box to the inlet to the column before being measured at the detector. A thermocouple, thermocouple temperature controller, and a heat wrap were installed on the gas source and pressure regulator/gauge to monitor and control temperature.

Tests were run varying the temperature of the gas source and the sample line to quantify the effect on the ethanol measurement. FIG. 17 depicts that temperature variation at the gas source has an effect on the ethanol temperature at a high temperature, above 80° C., and little effect at temperatures below 80° C. The key of FIG. 17 depicts the temperature in Celsius at the components for each of the trials. “Cy” stands for cylinder (gas source), “am” stands for ambient or room temperature (between 23° C. and 25° C., “ln” stands for sample line, “sl” stands for sample loop, and “col” stands for column. The number next to the symbol refers to the temperature in Celsius at that component during a trial. The effect of the gas source temperature on the ethanol measurement is less than the effect of the temperature variation with the sample line on the system.

### Example 7

### Procedure for Purging the Pressure Regulator/Gauge

The procedure for purging the pressure regulator/gauge is as follows:

1. A pressure regulator is attached to a gas source. The regulator outlet is closed while the regulator is turned clockwise to the maximum pressure the outlet pressure gauge allows, e.g., 60 psi in this instance when the gas source is 600 psi. This allows the regulator to be pressurized with the content of the gas tank.

2. The regulator is turned fully counter-clockwise until there is not resistance to further turning. Please note that in this instance, the outlet pressure still reads 60 psi.

3. The regulator is opened. A hissing noise should then be heard, when the regulator is bleeding gas content.

4. The above procedure (steps 1-3) is repeated 14 more times for a total of 15 purges.

After the pressure regulator has been purged fifteen times, the sample line is re-attached for testing.

### Example 8

### Procedure for Setting Up System at Sub-Ambient Temperatures

Previous tests conducted with the GC system (gas source, pressure regulator/gauge sample line, sample loop, inlet, and column) operating at a homogenous temperature from 30° C. to 105° C. suggested the precision for ethanol measurement improved when the tests were conducted at lower homogenous temperatures. In order to evaluate if this trend extrapolates to sub-ambient temperatures, experiments were conducted with the system cooled down below room temperature respectively.

The following description illustrates how the various system components are chilled to below room temperature.

A piece of ¼ inch OD copper tubing is wrapped around the gas source and pressure regulator/gauge, serving as a cooling coil. The gas source is further insulated with a piece of aluminum foil. The sample line needs to be chilled as well. The 1/16″ silco-steel sample line is wrapped around an ¼ inch OD copper tubing and insulated. The ¼ inch OD copper tubing cooling coils for cooling the gas source, the pressure regulator/gauge, and the sample line are connected up to a Remcor Model 550A Chiller.

The sample loop is chilled by a cooling bath that mixes dry ice in iso-propanol in an insulated styrofoam cup. Due to gradual temperature rise as the dry ice is depleted via evaporative loss, fresh pieces of dry ice (please refer to FIG. 11) are periodically added to try to maintain constant sample loop temperature.

The GC is cooled utilizing liquid nitrogen, which is fed into the inlet and GC oven via the cryogenic valve. Other approaches for chilling such as Peltier devices may be used to conduct the ethanol testing at sub-ambient temperature.

### Example 9

### Procedure for Applying Back Pressure to a Sample Loop to Quantify the Effect of Back Pressure on Ethanol Measurements

It has been observed that back pressure on the sample loop can affect the ethanol measurement of a GC. Therefore, a procedure is put forth for applying back pressure to the sample loop. Two tests were conducted: a test utilizing water and a test applying pressure by partially blocking the outlet of the tubing. The first test somewhat illustrated the effect back pressure has on the ethanol measurement and the second test, illustrated the effect more definitively. The test applying back pressure with water utilizes tubing that needs to be connected to the exhaust outlet of the GC which is connected to outlet port of the sample loop actuator valve. The tubing is then submerged in a beaker filled with water. The tubing path goes along the outside of the GC and then over to the outlet port of the sample loop actuator valve. The back pressure is applied to the sample loop to help ensure constant back pressure is applied to the sample loop. Tests were taken with and without back pressure to determine the effect on the ethanol measurement. Initial results showed an effect, but the limited amount of pressure applied and the variation in the measurement due to the test being conducted at a time when the system was non-homogeneous made it difficult to show a correlation. Therefore, a more definitive test conducted with a homogeneous system was conducted.

While the back pressure achieved by submerging the plastic tubing in water is minimal, greater back pressure could be achieved by partially blocking the tube outlet. When a greater back pressure is applied, the ethanol peak height is greatly increased as shown in the plot in FIG. 12. The procedure demonstrates the role of applying a constant back pressure on the sample loop to minimize the variation in the ethanol measurement.

TABLE 2

| | | | |
|---|---|---|---|
| Target | Actual | Target | Actual |
| (ppm) | (ppm) | (BrAC) | (BrAC) |

| | | | | | |
|---|---|---|---|---|---|
| Non- | Precision | 1.5622 | 55 | 0.0006000 | +0.021211 |
| Homo- | (max-min) | | | | |
| genous | Accuracy | +/−0.7811 | +126 | +/−0.000300 | 0.048519 |
| (FIG. 8) | (avg delta) | | | | |
| Partial- | Precision | 1.5622 | 8 | 0.0006000 | 0.003113 |
| Homo- | (max-min) | | | | |
| genous | Accuracy | +/−0.7811 | −6 | +/−0.000300 | −0.002350 |
| (FIG. 9) | (avg delta) | | | | |
| Homo- | Precision | 1.5622 | 0.8991 | 0.0006000 | 0.000345 |
| genous | (max-min) | | | | |
| (FIG. | Accuracy | +/−0.7811 | +0.3961 | +/−0.000300 | +0.000154 |
| 10) | (avg delta) | | | | |

TABLE 3

| | | | | DADSS |
|---|---|---|---|---|
| GC | GC | BrAC GC | BrAC GC | Required |
| Ethanol | Ethanol | Ethanol | Ethanol | BrAC |
| Gas Peak | Gas Peak | Tolerance | Tolerance | Ethanol |
| Height | Height | (Precision) | (Accuracy) | Tolerance |
| ppm | % BrAC | % BrAC | % BrAC | +/−% BrAC |
| 207.825872 | 0.07878 | 0.000260537 | 0.001219091 | 0.00030 |
| 208.391833 | 0.07900 | 0.000043168 | 0.001001722 | 0.00030 |
| 208.369994 | 0.07899 | 0.000051555 | 0.001010109 | 0.00030 |
| 208.304588 | 0.07896 | 0.000076676 | 0.001035230 | 0.00030 |
| 208.126050 | 0.07890 | 0.000145247 | 0.001103801 | 0.00030 |
| 209.004924 | 0.07923 | 0.000192303 | 0.000766251 | 0.00030 |
| 208.833042 | 0.07917 | 0.000126288 | 0.000832266 | 0.00030 |
| 207.634850 | 0.07871 | 0.000333903 | 0.001292457 | 0.00030 |
| 208.466720 | 0.07903 | 0.000014406 | 0.000972960 | 0.00030 |
| 208.992206 | 0.07923 | 0.000187418 | 0.000771136 | 0.00030 |
| 209.110932 | 0.07927 | 0.000233017 | 0.000725537 | 0.00030 |
| 208.954951 | 0.07921 | 0.000173110 | 0.000785444 | 0.00030 |
| 208.648658 | 0.07910 | 0.000055471 | 0.000903083 | 0.00030 |
| 208.394567 | 0.07900 | 0.000042117 | 0.001000672 | 0.00030 |
| Average | Average | | | |
| 208.50423 | 0.07904 | | | |

TABLE 4

| | | | | DADSS |
|---|---|---|---|---|
| GC | GC | BrAC GC | BrAC GC | Required |
| Ethanol | Ethanol | Ethanol | Ethanol | BrAC |
| Gas Peak | Gas Peak | Tolerance | Tolerance | Ethanol |
| Height | Height | (Precision) | (Accuracy) | Tolerance |
| ppm | % BrAC | % BrAC | % BrAC | +/−% BrAC |
| 210.977962 | 0.07999 | 0.081030549 | 0.000008464 | 0.00030 |
| 211.340902 | 0.08013 | 0.081169944 | 0.000130931 | 0.00030 |
| 211.300823 | 0.08012 | 0.081154551 | 0.000115538 | 0.00030 |
| 211.625142 | 0.08024 | 0.081279112 | 0.000240099 | 0.00030 |
| 211.719115 | 0.08028 | 0.081315205 | 0.000276191 | 0.00030 |
| 211.388050 | 0.08015 | 0.081188053 | 0.000149039 | 0.00030 |
| 211.323975 | 0.08012 | 0.081163443 | 0.000124429 | 0.00030 |
| 210.887155 | 0.07996 | 0.080995673 | 0.000043341 | 0.00030 |
| 211.500894 | 0.08019 | 0.081231392 | 0.000192379 | 0.00030 |
| 211.530287 | 0.08020 | 0.081242682 | 0.000203668 | 0.00030 |
| 211.145904 | 0.08006 | 0.081095051 | 0.000056038 | 0.00030 |
| 211.052003 | 0.08002 | 0.081058987 | 0.000019973 | 0.00030 |
| 211.664393 | 0.08026 | 0.081294188 | 0.000255174 | 0.00030 |
| 211.557342 | 0.08021 | 0.081253073 | 0.000214059 | 0.00030 |
| Average | Average | | | |
| 211.35814 | 0.08014 | | | |

It will be understood that the foregoing is only illustrative of the principles of the invention, and that various modifications can be made by those skilled in the art without departing from the scope and spirit of the invention. One skilled in the art will appreciate that the present invention can be practiced by other than the described embodiments, which are presented for purposes of illustration and not of limitation, and the present invention is limited only by the claims that follow.

1. A molecular detection system, comprising:
(a) a gas chromatograph;
(b) a gas source containing a gas mixture where release of the gas mixture is controlled by a regulator;
(c) a sample loop which contains and transfers a predetermined volume of a sample of the gas mixture into the gas chromatograph; and
(d) a sample line connecting the gas source and the sample loop and providing fluid communication there between; wherein
the gas chromatograph, the gas source, the sample loop, the sample line and the regulator are each maintained at a temperature within ±2.0° C. of a preselected temperature wherein the preselected temperature is selected from 50° C. or below.

2. The system of claim 1, further comprising a back pressure-controller in fluid communication with the sample loop for maintaining a constant back pressure on the sample loop.

3. The system of claim 2, wherein the back pressure is held constant at a pressure greater than atmospheric pressure.

4. The system of claim 3, wherein the back pressure is held constant at a pressure selected from about 1013 mbar to about 1075 mbar.

5. The system of claim 1, wherein the preselected temperature is selected from between 0° C. and 34° C.

6. The system of claim 1, wherein the gas chromatograph, the gas source, the sample loop, the sample line and the regulator are each maintained at a temperature within ±1.0° C. of the preselected temperature.

7. The system of claim 1, wherein the volume of the sample loop is selected from 0.5 mL to 5.0 mL.

8. The system of claim 7, wherein the volume of the sample loop is selected from 0.5 to 2.0 mL.

9. The system of claim 1, wherein the sample line has an interior surface substantially covered with a passive material.

10. The system of claim 9, wherein the passive material is selected from one or more of silcosteel, silicon dioxide, and metal oxides.

11. The system of claim 10, wherein the passive material is silcosteel.

12. The system of claim 1, wherein the sample line has an internal diameter of ⅛ inches or less.

13. The system of claim 12, wherein the sample line has an internal diameter of 1/16 inches or less.

14. The system of claim 1, wherein the regulator is substantially covered on the interior surface with one or more passive materials.

15. The system of claim 14, wherein the passive material is selected from one or more of silcosteel, silicon dioxide, and a metal oxide.

16. The system of claim 15, wherein the passive material is silcosteel.

17. The system of claim 1, wherein the gas mixture contains one or more analytes.

18. The system of claim 17, wherein the one or more analytes have molecular weights of 200 g/mol or below.

19. Use of the system of claim 1, for detecting and quantifying analytes in a gas sample, comprising:
a) preselecting a temperature below 50° C.;
b) heating or cooling the gas chromatograph, the gas source, the sample loop, the sample line and the regulator at a temperature within ±2.0° C. of the preselected temperature;
c) adjusting the regulator to release the gas mixture from the gas source to the sample line and the sample loop;
d) injecting a sample of the gas mixture from the sample loop into the column of the GC;
e) detecting and quantifying the analytes in the gas sample with a detector; and
f) maintaining the components of the detection system at ±2.0° C. of the preselected temperature throughout steps c through e.

20. A method for detecting and quantifying one or more analytes in a gas sample, comprising:
a) preselecting a temperature below 50° C.;
b) heating or cooling the components of a molecular detection system in contact with the gas mixture to within ±2.0° C. of the preselected temperature, wherein the components of the molecular detection system in contact with the gas mixture comprise a gas chromatograph, a gas source containing a gas sample where release of the sample is controlled by the regulator, a sample loop which contains and transfers a predetermined volume of sample gas into the gas chromatograph and the sample line which connects the gas source and the sample loop and provides fluid communication there between;
c) adjusting the regulator to release the gas sample from the gas source to the sample line and the sample loop;
d) injecting the gas sample from the sample loop into the column of the GC;
e) detecting and quantifying the analytes in the gas sample with a detector; and
f) maintaining the components of the detection system at ±2.0° C. of the preselected temperature throughout steps c through e.

21. The method of claim 20, further comprising controlling the back pressure on the sample loop by appending a back pressure-controller to the sample loop.

22. The method of claim 21, wherein the back pressure of the sample loop is held at a constant pressure greater than atmospheric pressure.

23. The method of claim 22, wherein the back pressure is held at a pressure selected from at least 10 mbar greater than atmospheric pressure.

24. The method of claim 20, wherein the volume of the sample loop is selected from 0.5 mL to 5.0 mL.

25. The method of claim 24, wherein the volume of the sample loop is about 1.0 mL.

26. The method of claim 20, wherein the preselected temperature is selected from 0° C. to 34° C.

27. The method of claim 20, wherein the components of the molecular detection system are heated or cooled to within ±1.0° C. of the preselected temperature.

28. The method of claim 20, wherein the components of the molecular detection system are maintained within ±1.0° C. of the preselected temperature throughout steps c through e.

29. The method of claim 20, wherein the preselected temperature at the components is monitored and maintained with one or more thermocouples and temperature controllers.

30. The method of claim 20, wherein the preselected temperature at one or more components is monitored and maintained with one or more thermistors.
